(19) United States
(12) Patent Application Publication
(10) Pub. No.: US 2017/0316787 A1
(43) Pub. Date: Nov. 2, 2017

(54) AUDIO WATERMARKING SYSTEM AND PROCESSES

(71) Applicant: Quentin Wayne Gilkey, ENCINO, CA (US)

(72) Inventor: Quentin Wayne Gilkey, ENCINO, CA (US)

(21) Appl. No.: 15/582,279

(22) Filed: Apr. 28, 2017

Related U.S. Application Data
(60) Provisional application No. 62/329,034, filed on Apr. 28, 2016.

(51) Int. Cl. G10L 19/018; G06F 21/16; H04H 60/04; H04L 29/06

(52) U.S. Cl. CPC G10L 19/018; H04L 63/08; G06F 21/16; H04H 60/04; G06F 2221/0737

(57) ABSTRACT

An audio watermarking system and processes are disclosed. A process includes steps for assigning an audio watermarking plug-in tool to a master channel of an audio content project in a digital audio workstation software application, editing the audio content project, and saving the watermarked audio content. Another process includes steps for assigning an audio watermarking plug-in tool to a master channel of an audio content project in a digital audio workstation software application, editing the audio content project, saving the watermarked audio content, sharing the watermarked audio content, and automatically saving the watermarked audio content in an audio content database connected to a server computer. A cloud-network audio watermarking system includes at least one digital audio workstation computing device, a set of client computing devices for playback of watermarked audio content, an audio watermarking server, and a watermarked audio content database.

### CLAIM OF BENEFIT TO PRIOR APPLICATION

This application claims benefit to U.S. Provisional Patent Application 62/329,034, entitled “An audio plugin software that watermarks audio with various data to prevent online leaks also allowing the user to transfer that audio with valid email account,” filed Apr. 28, 2016. The U.S. Provisional Patent Application 62/329,034 is incorporated herein by reference.

### BACKGROUND

Embodiments of the invention described in this specification relate generally to systems to track audio, and more particularly, to an audio watermarking system and processes.

Currently musicians, composers, producers, etc., have to rely on the trust and faith of others when they distribute their music. The only way to track that audio is through fingerprinting and watermarking which is mainly done if you are signed to a major music company (hereinafter referred to as a “label” or a “record label”). The label handles this by sending an unprotected song to a third party watermarking company who then embeds a code into the audio file and returns it to the label.

However, it is rarely found that anyone independent (unsigned) are watermarking audio. In fact, currently there is no way to directly send to a person's email from the digital audio workstation (DAW) software and instantly be able to listen to that audio file.

Thus, present users must trust that when they send their unprotected file to a third party company that their music will not be leaked or stolen.

Therefore, what is needed is a way to allow the user to protect his or her music at the source of creation, all while creating a paper trail of who and/or where it was delivered to.

### BRIEF DESCRIPTION

Novel audio watermarking system and processes are disclosed. Some embodiments provide a process for watermarking an audio content file. Some embodiments provide a process for sharing a watermarked audio content file. Some embodiments include a cloud-network audio content watermarking system.

In some embodiments, the process for watermarking an audio content file includes steps for (i) assigning an audio watermarking plug-in tool to a master channel of an audio content project in a digital audio workstation software application, (ii) editing the audio content project, and (iii) saving the watermarked audio content.

In some embodiments, the process for sharing a watermarked audio content file includes steps for (i) assigning an audio watermarking plug-in tool to a master channel of an audio content project in a digital audio workstation software application, (ii) editing the audio content project, (iii) saving the watermarked audio content, (iv) sharing the watermarked audio content, and (v) automatically saving the watermarked audio content in an audio content database connected to a server computer.

In some embodiments, the cloud-network audio watermarking system includes at least one digital audio workstation computing device, a set of client computing devices for playback of watermarked audio content, an audio watermarking server, and a watermarked audio content database.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a process for watermarking an audio content file in some embodiments.

FIG. 2 conceptually illustrates a process for sharing a watermarked audio content file in some embodiments.

FIG. 3 conceptually illustrates a network architecture of an audio content watermarking system in some embodiments.

FIG. 4 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments of the invention include a novel audio content watermarking system and audio watermarking processes. Some embodiments provide a process for watermarking an audio content file. Some embodiments provide a process for sharing a watermarked audio content file. Some embodiments include a cloud-network audio content watermarking system.

In this specification, there are several descriptions of methods and processes that are implemented as software applications, software plug-in tools, or computer programs which run on computing devices to perform the steps of audio watermarking methods and/or processes. However, it should be noted that for the purposes of the embodiments described in this specification, the word “method” is used interchangeably with the word “process”. Audio watermarking processes or methods for watermarking audio content files or for sharing watermarked audio content files are described, therefore, by reference to example methods that conceptually illustrate steps of audio watermarking processes. The audio watermarking technology is described, therefore, by reference to example audio watermarking processes.

As stated above, musicians, composers, producers, etc., have to currently rely on the trust and faith of others when they distribute their music because the only way to track that audio is through fingerprinting and watermarking which is mainly done if you are signed to a major music company (hereinafter referred to as a “label” or a “record label”). However, it is rarely found that anyone independent (unsigned) are watermarking audio. In fact, currently there is no way to directly send to a person's email from the DAW software and instantly be able to listen to that audio file. Thus, present users must trust that when they send their unprotected file to a third party company that their music will not be leaked or stolen.

Embodiments of the audio watermarking system and processes described in this specification solve such problems by software plug-in tools that implement the processes and allow users in real time to create a watermark when they are bouncing (printing) their audio directly from their local DAW software. Specifically, the software generates and embeds an inaudible code throughout the audio file prior to being written on the user's local drive and prior to it being uploaded to our server for the most secure transfer process available. The software also allows the user to transfer this music directly to anyone with a valid email and to be listened to directly from the email body. And that file, if the user selected the option, is fully watermarked with meta-data about the song, the sender's information and the recipient's information. If there were ever an issue of copyright infringement we could process that file back through our system to see who it was originally sent to and prove without a doubt where that file has been.

Embodiments of the audio watermarking system and processes described in this specification differ from and improve upon currently existing options. In particular, some embodiments of the audio watermarking system and processes differ by completely eliminating the idea of hiring third party audio watermarking services and putting the power in the user's hands. In addition, these embodiments improve upon the currently existing options by making the user feel they have more power and control of their art. In essence, the audio watermarking system and processes of the present disclosure allow users to protect their art at the source of creation, all while creating a paper trail of who and/or where it was delivered to.

The audio watermarking system and processes of the present disclosure may be comprised of the following elements. This list of possible constituent elements is intended to be exemplary only and it is not intended that this list be used to limit the audio watermarking system and processes of the present application to just these elements. Persons having ordinary skill in the art relevant to the present disclosure may understand there to be equivalent elements that may be substituted within the present disclosure without changing the essential function or operation of the audio watermarking system and processes.

1. A computer with audio input and output capability

2. Any major DAW software (e.g., ProTools, Logic, etc.)

3. Audio content

4. Color monitor

5. Computer keyboard

6. Mouse, trackball, or trackpad

7. The subject computer-readable medium (the software)

The audio watermarking system and processes of the present disclosure generally work by first opening a session in the DAW software. The DAW is allowing the user via the Master output track to aurally perceive the music that is being played back from the DAW. The DAW can house one to a few hundred tracks of audio which is all summed down to master output tracks. The audio watermarking system and processes, when implemented as software, insert on a “master output track” within the DAW. Users are asked to fill in the meta data, including, without limitation, the artist name, album name, track name, ISRC code number, etc. If the user is intending on transferring this file via email then the user must also fill in their email address as well as the recipients email address. When the user is done with the song he or she can begin the process called bouncing or printing which yields the final mono, stereo, or surround sound audio file. As the audio passes through our software inserted on the master output track the software embeds an inaudible code throughout the audio file. That embedded code holds all of the meta data entered earlier by the user and can be recalled by way of a recovery process.

Several more detailed embodiments are described in the sections below. Section I describes some example audio watermarking processes. Section II describes a cloud-network audio content watermarking system. Finally, section VII describes an electronic system that implements one or more of the methods and processes.

### I. Audio Watermarking Processes

In some embodiments, the process for watermarking an audio content file includes steps for (i) assigning an audio watermarking plug-in tool to a master channel of an audio content project in a digital audio workstation software application, (ii) editing the audio content project, and (iii) saving the watermarked audio content.

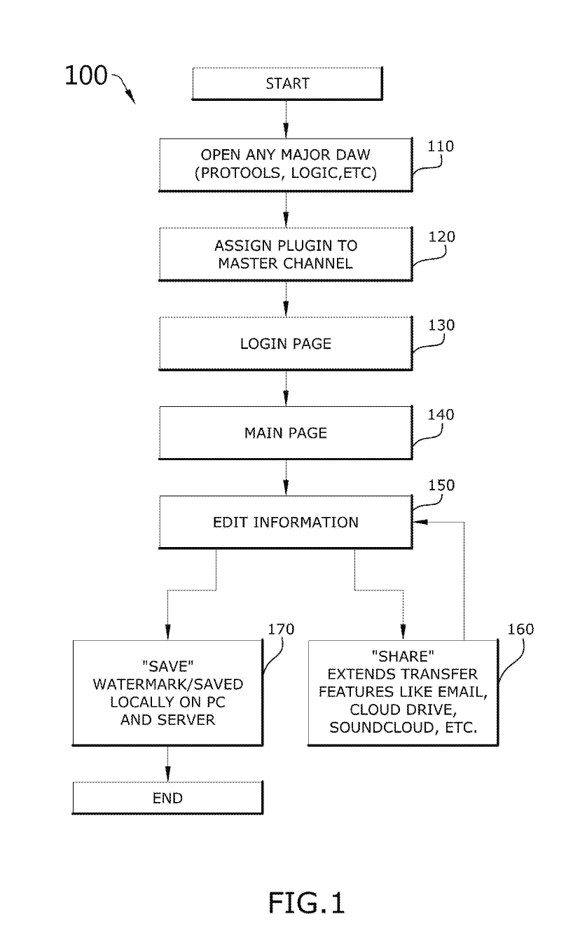

By way of example, FIG. 1 conceptually illustrates a process 100 for watermarking an audio content file in some embodiments. As shown in this figure, the process 100 starts upon the user opening (at 110) a digital audio workstation (DAW). For example, the user may launch a commercial DAW, such as ProTools or Logic. Next, the process 100 assigns (at 120) a plug-in tool for watermarking audio content to a master channel in the DAW.

In some embodiments, the login page is next displayed (at 130) by the process 100. After the user successfully logs in, the process 100 then displays the main page (at 140). After the main page is displayed, the user begins to edit information (at 150).

In some embodiments, the process 100 continues to the next step of sharing (at 160) the watermarked audio content via extended transfer features, such as e-mail, cloud drive, Sound Cloud, etc. After sharing the watermarked audio content, the process 100 returns to step 150 to edit information. In some embodiments, the user can again share the watermarked audio content file with others, repeating step 160 and again returning to step 150. However, in some embodiments, the process 100 saves (at 170) the watermarked audio content file. In some embodiments, the watermarked audio content file can be saved locally on a computing device. After saving the watermarked audio content file, the process 100 of some embodiments ends.

In some embodiments, the process for sharing a watermarked audio content file includes steps for (i) assigning an audio watermarking plug-in tool to a master channel of an audio content project in a digital audio workstation software application, (ii) editing the audio content project, (iii) saving the watermarked audio content, (iv) sharing the watermarked audio content, and (v) automatically saving the watermarked audio content in an audio content database connected to a server computer.

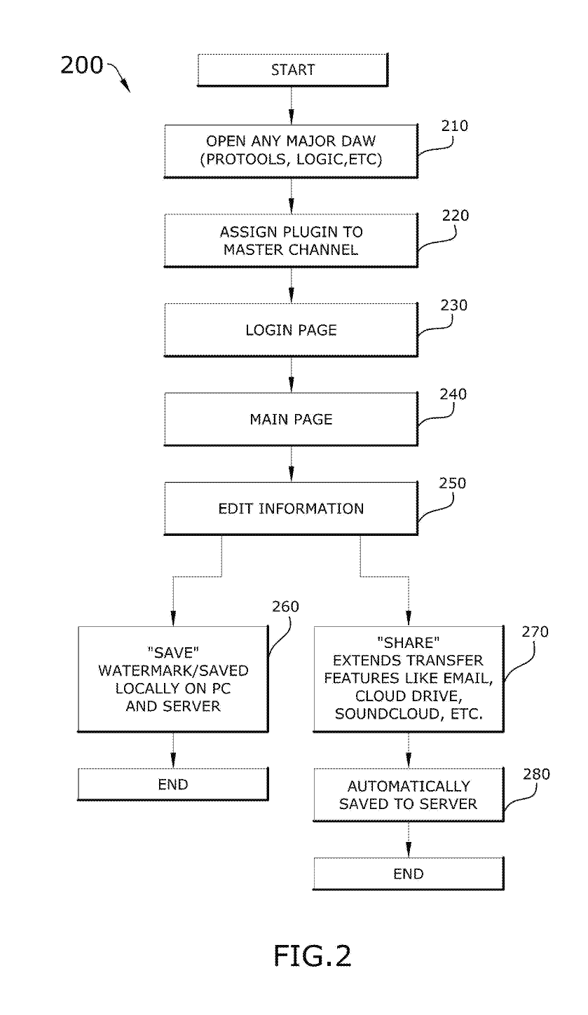

By way of example, FIG. 2 conceptually illustrates a process 200 for sharing a watermarked audio content file in some embodiments. As shown in this figure, the process 200 starts upon the user opening (at 210) a digital audio workstation (DAW), such as ProTools or Logic. Next, the process 200 assigns (at 220) the plug-in tool for watermarking audio content to the master channel in the DAW. In some embodiments, the process 200 displays (at 230) the login page. After the user successfully logs in, the process 200 then displays the main page (at 240). After the main page is displayed, the user begins to edit information (at 250).

In some embodiments, the process 200 saves (at 260) the watermarked audio content file. In some embodiments, the watermarked audio content file can be saved locally on a computing device. Then the process 200 ends.

Alternatively, the process 200 of some embodiments shares (at 270) the watermarked audio content file via extended transfer features, such as e-mail, cloud drive, Sound Cloud, etc. After sharing the watermarked audio content, the process 200 automatically saves (at 280) the watermarked audio content file on the server. After saving the watermarked audio content file, the process 200 of some embodiments ends.

To make the audio watermarking system and processes of the present disclosure, the processes can be implemented as plug-in software. In some embodiments, the plug-in software tightly integrates itself with database hosted by a cloud server. For example, the database may be a MySQL database (DB) hosted on the cloud server. To make an audio watermarking system, therefore, one would create software that is able to perform the operations of the processes and provide the user with the same abilities as described above. Several additions can be added to the software. The idea of including a way to do multiple files, video, documents, sheet music, etc.

To use the audio watermarking system and processes of the present disclosure, the user bounces their choice of audio from the DAW through our software. The audio watermarking plug-in software embeds a code in real-time with information entered by the user prior to initiating the bounce process. The user can now transfer the watermarked file to a recipient or save the file on the local computer system. The user has options to encrypt said audio file, allow recipient to be able to download, and be able to designate a duration the file will be available.

### II. Audio Content Watermarking System

In some embodiments, the cloud-network audio watermarking system includes at least one digital audio workstation computing device, a set of client computing devices for playback of watermarked audio content, an audio watermarking server, and a watermarked audio content database.

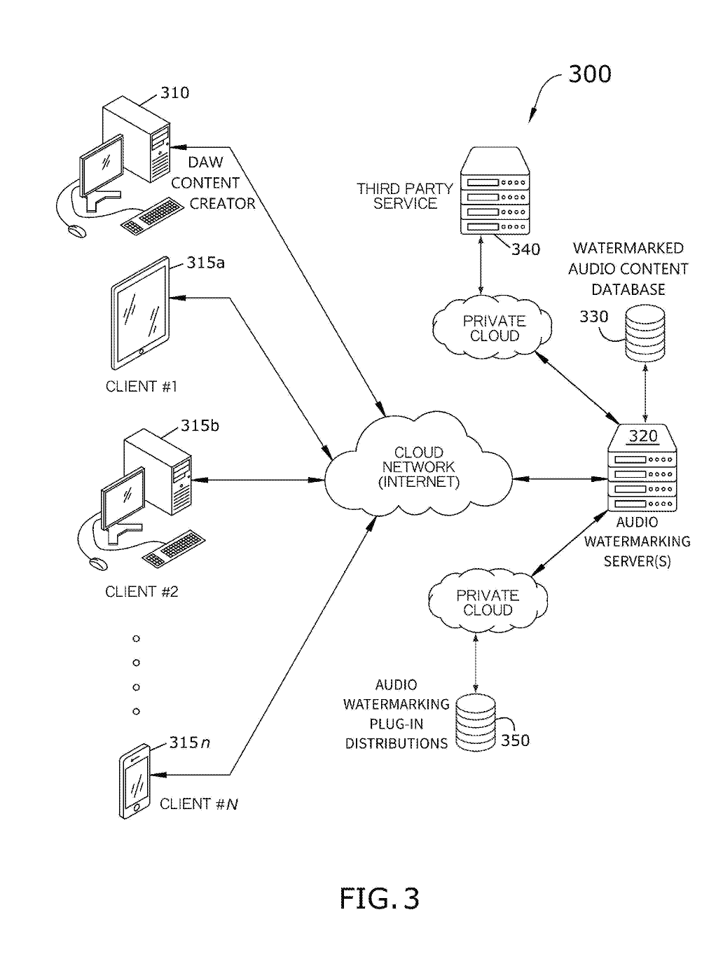

By way of example, FIG. 3 conceptually illustrates a network architecture of an audio content watermarking system 300 in some embodiments. As shown in this figure, the audio content watermarking system 300 includes a digital audio workstation (DAW) content creator computing device 310, a first client computing device 315a, a second client computing device 315b, and a last client computing device 315n. In some embodiments, the first client computing device 315a, the second client computing device 315b, and/or the last client computing device 315n receive and play the watermarked audio content file(s) when made available on a content server to share with client computing devices over the cloud.

In some embodiments, the audio content watermarking system 300 further includes one or more audio watermarking server(s) 320, a watermarked audio content database 330, one or more third party service(s) 340, and an audio watermarking plug-in distributions database 350. In some embodiments, the audio watermarking server(s) 320 receive audio content creations from the DAW content creator computing device 310 over a cloud network (e.g., the Internet) and watermarks the audio file for distribution and tracking. When the DAW content creator computing device 310 chooses to share the watermarked audio content, the audio watermarking server(s) 320 transmit the watermarked audio content to one or more of the first client computing device 315a, the second client computing device 315b, and/or the last client computing device 315n. In some embodiments, the audio watermarking server(s) 320 tracks playback data and re-distribution behavior of users of the first client computing device 315a, the second client computing device 315b, and/or the last client computing device 315n.

In some embodiments, the audio watermarking server(s) 320 stores watermarked audio content files in the watermarked audio content database 330. In some embodiments, the audio watermarking server(s) 320 also stores playback and re-distribution tracking data along with each associated watermarked audio content file stored in the watermarked audio content database 330.

In some embodiments, the first client computing device 315a, the second client computing device 315b, and/or the last client computing device 315n retrieve the watermarked audio content file(s) that are shared via a third party service 340, such as Sound Cloud, a commercial webmail service, or another third party cloud-based content service.

In some embodiments, the audio watermarking server(s) 320 also stores distributions of the audio watermarking plug-in software tools in a database 350. For example, the audio watermarking plug-in software may be available on different client computing device platforms, including Windows, Mac, Android, and iOS, among others.

The present invention may be embodied within a system, a method, a computer program product or any combination thereof. The computer program product may include a non-transitory computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. Additionally, the software could be written directly into an existing or new digital audio workstation (DAW) software as a part of the DAW's architecture, or embedded on a storage device of a hardware-based digital audio workstation computing device or machine.

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

### III. Electronic System

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

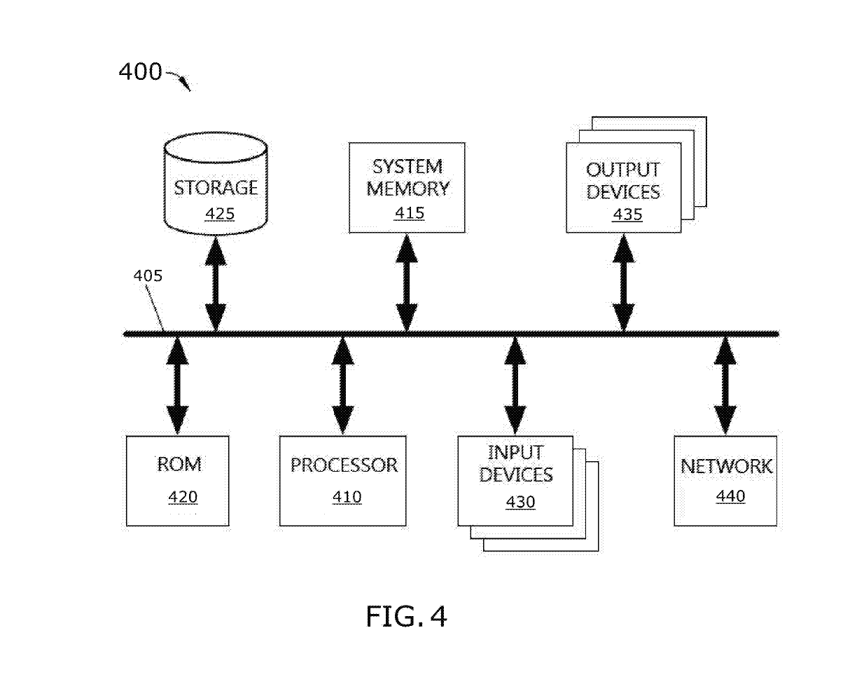

FIG. 4 conceptually illustrates an electronic system 400 with which some embodiments of the invention are implemented. The electronic system 400 may be a computer, phone, PDA, or any other sort of electronic device. Such an electronic system includes various types of computer readable media and interfaces for various other types of computer readable media. Electronic system 400 includes a bus 405, processing unit(s) 410, a system memory 415, a read-only 420, a permanent storage device 425, input devices 430, output devices 435, and a network 440.

The bus 405 collectively represents all system, peripheral, and chipset buses that communicatively connect the numerous internal devices of the electronic system 400. For instance, the bus 405 communicatively connects the processing unit(s) 410 with the read-only 420, the system memory 415, and the permanent storage device 425.

From these various memory units, the processing unit(s) 410 retrieves instructions to execute and data to process in order to execute the processes of the invention. The processing unit(s) may be a single processor or a multi-core processor in different embodiments.

The read-only-memory (ROM) 420 stores static data and instructions that are needed by the processing unit(s) 410 and other modules of the electronic system. The permanent storage device 425, on the other hand, is a read-and-write memory device. This device is a non-volatile memory unit that stores instructions and data even when the electronic system 400 is off. Some embodiments of the invention use a mass-storage device (such as a magnetic or optical disk and its corresponding disk drive) as the permanent storage device 425.

Other embodiments use a removable storage device (such as a floppy disk or a flash drive) as the permanent storage device 425. Like the permanent storage device 425, the system memory 415 is a read-and-write memory device. However, unlike storage device 425, the system memory 415 is a volatile read-and-write memory, such as a random access memory. The system memory 415 stores some of the instructions and data that the processor needs at runtime. In some embodiments, the invention's processes are stored in the system memory 415, the permanent storage device 425, and/or the read-only 420. For example, the various memory units include instructions for processing appearance alterations of displayable characters in accordance with some embodiments. From these various memory units, the processing unit(s) 410 retrieves instructions to execute and data to process in order to execute the processes of some embodiments.

The bus 405 also connects to the input and output devices 430 and 435. The input devices enable the user to communicate information and select commands to the electronic system. The input devices 430 include alphanumeric keyboards and pointing devices (also called “cursor control devices”). The output devices 435 display images generated by the electronic system 400. The output devices 435 include printers and display devices, such as cathode ray tubes (CRT) or liquid crystal displays (LCD). Some embodiments include devices such as a touchscreen that functions as both input and output devices.

Finally, as shown in FIG. 4, bus 405 also couples electronic system 400 to a network 440 through a network adapter (not shown). In this manner, the computer can be a part of a network of computers (such as a local area network (“LAN”), a wide area network (“WAN”), or an intranet), or a network of networks (such as the Internet). Any or all components of electronic system 400 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIGS. 1 and 2 conceptually illustrate processes. The specific operations of each process may not be performed in the exact order shown and described. Specific operations may not be performed in one continuous series of operations, and different specific operations may be performed in different embodiments. Furthermore, each process could be implemented using several sub-processes, or as part of a larger macro process. Thus, one of ordinary skill in the art would understand that the invention is not to be limited by the foregoing illustrative details, but rather is to be defined by the appended claims.

I claim:

1. A non-transitory computer readable medium storing a program which when executed by at least one processing unit of a computing device watermarks audio content, said program comprising sets of instructions for:
assigning an audio watermarking plug-in tool to a master channel of an audio content project in a digital audio workstation software application;
editing the audio content project; and
saving the watermarked audio content.

2. The non-transitory computer readable medium of claim 1, wherein the program further comprises a set of instructions for displaying a login page.

3. The non-transitory computer readable medium of claim 2, wherein the program further comprises a set of instructions for receiving login credentials from a user of the digital audio workstation software application.

4. The non-transitory computer readable medium of claim 1, wherein the program further comprises a set of instructions for displaying a main page of a cloud-network audio watermarking application service.

5. The non-transitory computer readable medium of claim 1, wherein the program further comprises a set of instructions for sharing the watermarked audio content.

6. The non-transitory computer readable medium of claim 5, wherein the set of instructions for sharing the watermarked audio content comprises a set of instructions for providing extended transfer features that allow the user to share the watermarked audio content.

7. The non-transitory computer readable medium of claim 6, wherein the extended transfer features comprise a cloud-network database with watermarked audio content available to retrieve.

8. The non-transitory computer readable medium of claim 6, wherein the extended transfer features comprise a cloud-network music playback service.

9. The non-transitory computer readable medium of claim 6, wherein the extended transfer features comprise an email service.

10. The non-transitory computer readable medium of claim 1, wherein the set of instructions for saving the watermarked audio content comprises a set of instructions for saving the watermarked audio content locally on a client computing device.

11. The non-transitory computer readable medium of claim 1, wherein the set of instructions for saving the watermarked audio content comprises a set of instructions for saving the watermarked audio content in a cloud-network database with watermarked audio content.
